(19) United States
(12) Patent Application Publication
(10) Pub. No.: US 2017/0374646 A1
(43) Pub. Date: Dec. 28, 2017

(54) USER TERMINAL, RADIO BASE STATION AND RADIO COMMUNICATION METHOD

(71) Applicant: NTT DOCOMO, INC., Tokyo (JP)

(72) Inventors: Kazuaki Takeda, Tokyo (JP); Liu Liu, Beijing (CN); Huiling Jiang, Beijing (CN); Qin Mu, Beijing (CN)

(73) Assignee: NTT DOCOMO, INC., Tokyo (JP)

(21) Appl. No.: 15/544,909

(22) PCT Filed: Jan. 21, 2016
(86) PCT No.: PCT/JP2016/051700

§ 371 Date: Jul. 20, 2017

(30) Foreign Application Priority Data
Jan. 23, 2015 (JP) 2015-011091

(51) Int. Cl. H04W 68/02; H04W 72/04

(52) U.S. Cl. CPC H04W 68/02; H04W 72/042

(57) ABSTRACT

The present invention is designed so that communication can be carried out adequately even when the bandwidth to use is limited to partial reduced bandwidths in a system bandwidth. A user terminal, in which the bandwidth to use is limited to partial reduced bandwidths in a system bandwidth, has a receiving section that receives paging information that is transmitted in a predetermined subframe, and a control section that controls the receipt of a downlink shared channel and/or an enhanced downlink control channel by using information about a CFI (Control Format Indicator) value that is acquired based on the paging information, and the receiving section detects a common search space, which is allocated in a fixed starting location in the predetermined subframe, and receives the paging information indicated in the common search space.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, successor systems of LTE (also referred to as, for example, “LTE-advanced” (hereinafter referred to as “LTE-A”), “FRA” (Future Radio Access), and so on) are under study for the purpose of achieving further broadbandization and increased speed beyond LTE.

Now, accompanying the cost reduction of communication devices in recent years, active development is in progress in the field of technology related to machine-to-machine communication (M2M) to implement automatic control of network-connected devices and allow these devices to communicate with each other without involving people. In particular, of all M2M, 3GPP (3rd Generation Partnership Project) is promoting standardization with respect to the optimization of MTC (Machine-Type Communication), as a cellular system for machine-to-machine communication (see non-patent literature 2). MTC terminals are being studied for use in a wide range of fields, such as, for example, electric (gas) meters, vending machines, vehicles and other industrial equipment.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”
Non-Patent Literature 2: 3GPP TS 36.888 “Study on provision of low-cost Machine-Type Communications (MTC) User Equipments (UEs) based on LTE (Release 12)”

### SUMMARY OF INVENTION

### Technical Problem

From the perspective of reducing the cost and improving the coverage area in cellular systems, amongst all MTC terminals, low-cost MTC terminals (low-cost MTC UEs) that can be implemented in simple hardware structures have been increasingly in demand. Low-cost MTC terminals can be implemented by limiting the bandwidth to use in the uplink (UL) and the downlink (DL) to a portion of the system bandwidth. A system bandwidth is equivalent to, for example, an existing LTE band (for example, 20 MHz), a component carrier and so on.

However, when the bandwidth to use is limited to a portion of a system bandwidth, the signals and channels used in existing systems cannot be received. For example, in existing systems, a CFI (Control Format Indicator), which shows the number of OFDM symbols to constitute a downlink control channel (PDCCH), is transmitted in a PCFICH (Physical Control Format Indicator Channel).

A user terminal can judge the number of PDCCH-OFDM symbols in a predetermined transmission time interval (for example, a subframe) based on the CFI transmitted in the PCFICH. Also, in each subframe, after the PDCCH of the subframe is constituted by using a number of OFDM symbols, the PDSCH is constituted by using the rest of the OFDM symbols. Consequently, the user terminal can identify the starting location of a downlink shared channel (PDSCH) based on the CFI.

However, since the PCFICH is arranged over a system bandwidth, a user terminal (for example, an MTC terminal), in which the bandwidth to use is limited to reduced bandwidths, cannot detect the CFI in the existing PCFICH. As a result of this, there is a threat that the user terminal is unable to identify the starting symbol of the PDSCH (or the EPDCCH) in each subframe, and unable to communicate adequately.

The present invention has been made in view of the above, and it is therefore an object of the present invention to provide a user terminal, a radio base station and a radio communication method that allow adequate communication even when the bandwidth to use is limited to partial reduced bandwidths in a system bandwidth.

### Solution to Problem

One aspect of the present invention provides a user terminal, in which the bandwidth to use is limited to partial reduced bandwidths in a system bandwidth, and this user terminal has a receiving section that receives paging information that is transmitted in a predetermined subframe, and a control section that controls the receipt of a downlink shared channel and/or an enhanced downlink control channel by using information about a CFI (Control Format Indicator) value that is acquired based on the paging information, and the receiving section detects a common search space, which is allocated in a fixed starting location in the predetermined subframe, and receives the paging information indicated in the common search space.

### Advantageous Effects of Invention

The present invention allows adequate communication even when the bandwidth to use is limited to partial reduced bandwidths in a system bandwidth.

### BRIEF DESCRIPTION OF DRAWINGS

FIG. 1 provide diagrams, each showing an example of the arrangement of reduced bandwidths in a downlink system bandwidth;

FIG. 2 is a diagram to show an example of PDSCH allocation in MTC terminals;

FIG. 3 is a diagram to show an example of conventional PCFICH allocation;

FIG. 4 provide diagrams to show example cases in which the starting location of the PDSCH and/or the EPDCCH (CFI value) is assigned on a fixed basis;

FIG. 5 is a diagram to explain the operation of a user terminal when a system information change notification is received in paging information;

FIG. 6 provide diagrams to show examples of the operation of a user terminal when a system information change notification is received in paging information;

FIG. 7 provide diagrams to show example cases in which a CSS to specify paging information or paging information is allocated on a fixed basis;

FIG. 8 is a diagram to explain the operation of a user terminal when a RACH request included in paging information is received;

FIG. 9 provide diagrams to show examples of the operation of a user terminal when a CFI value change notification is received;

FIG. 10 provide diagrams to show examples of the operation of a user terminal when paging information that includes CFI value-related information is received;

FIG. 11 provide diagrams to show examples of the CFI value updating method for MTC terminals in RRC-connected mode;

FIG. 12 is a diagram to show a schematic structure of a radio communication system according to an embodiment of the present invention;

FIG. 13 is a diagram to show an example of an overall structure of a radio base station according to an embodiment of the present invention;

FIG. 14 is a diagram to show an example of a functional structure of a radio base station according to one embodiment of the present invention;

FIG. 15 is a diagram to show an example of an overall structure of a user terminal according to an embodiment of the present invention; and

FIG. 16 is a diagram to show an example of a functional structure of a user terminal according to an embodiment of the present invention.

### DESCRIPTION OF EMBODIMENTS

A study in progress to limit the processing capabilities of terminals by making the peak rate low, limiting the resource blocks, allowing limited RF reception and so on, in order to reduce the cost of MTC terminals. For example, the maximum transport block size in unicast transmission using a downlink data channel (PDSCH: Physical Downlink Shared Channel) is limited to 1000 bits, and the maximum transport block size in BCCH transmission using a downlink data channel is limited to 2216 bits. Furthermore, the downlink data channel bandwidth is limited to 6 resource blocks (also referred to as “RBs” (Resource Blocks), “PRBs” (Physical Resource Blocks), etc.). Furthermore, the RFs (Radio frequencies) to receive in MTC terminals are limited to one.

Furthermore, the transport block size and the resource blocks in low-cost MTC terminals (low-cost MTC UEs) are more limited than in existing user terminals, and therefore low-cost MTC terminals cannot connect with cells in compliance with LTE Rel. 8 to 11. Consequently, low-cost MTC terminals connect only with cells where a permission of access is reported to the low-cost terminals in broadcast signals. Furthermore, a study is in progress to limit not only downlink data signals, but also various control signals that are transmitted on the downlink (such as system information, downlink control information and so on), data signals and various control signals that are transmitted on the uplink and so on, to predetermined reduced bandwidths (for example, 1.4 MHz).

Such band-limited MTC terminals need to be operated in the LTE system bandwidth, considering the relationship with existing user terminals. For example, in a system bandwidth, frequency-multiplexing of band-limited MTC terminals and band-unlimited existing user terminals may be supported. Furthermore, band-limited user terminals might only support predetermined narrow-band RFs in the uplink and the downlink. Here, an MTC terminal refers to a terminal that supports only reduced a bandwidth, which constitutes a portion of a system bandwidth, as its maximum bandwidth, while an existing user terminal refers to a terminal that supports the system bandwidth (which is, for example, 20 MHz) as its maximum bandwidth.

That is, the upper limit of the bandwidth for use by MTC terminals is limited to reduced bandwidths, and, for existing user terminals, the system bandwidth is configured as the upper limit of the bandwidth for use. Since MTC terminals are designed based on reduced bandwidths, they have simplified hardware structures, and their processing capabilities are more limited than existing user terminals. Note that MTC terminals may be referred to as “low-cost MTC terminals,” “MTC UEs” and so on. Existing user terminals may be referred to as “normal UEs,” “non-MTC UEs,” category 1 UEs” and so on.

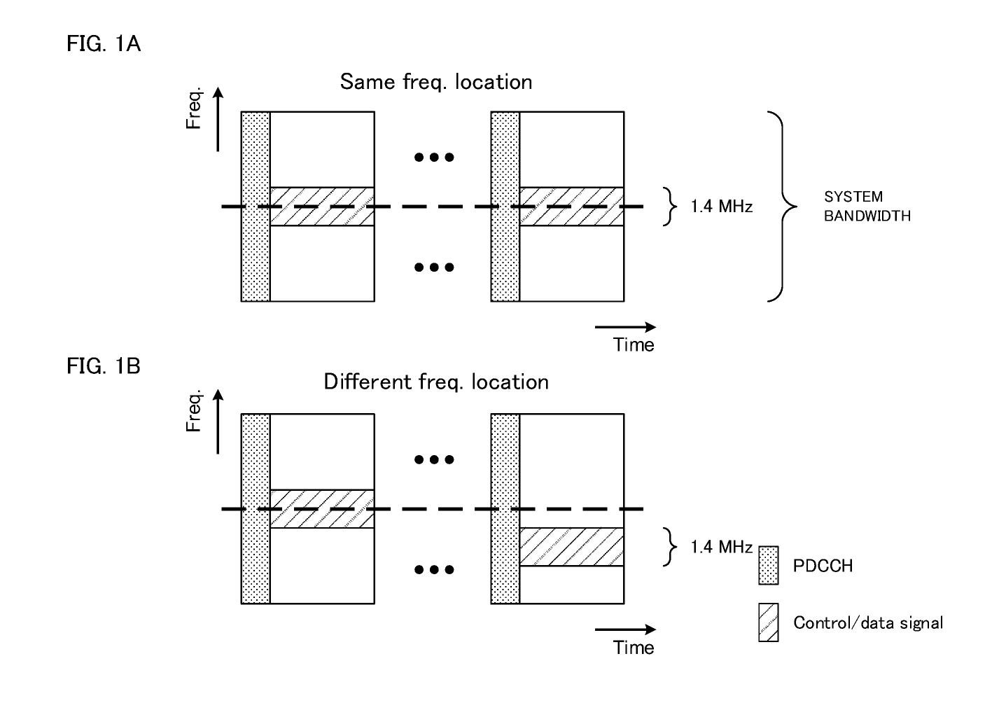

Now, the arrangement of reduced bandwidths in a downlink system bandwidth will be described with reference to FIG. 1. FIG. 1A shows the case where the bandwidth for use for MTC terminals is limited to a partial reduced bandwidth (for example, 1.4 MHz) in a system bandwidth. When a reduced bandwidth is fixed in a predetermined frequency location in a system bandwidth, no frequency diversity effect can be achieved, and therefore the spectral efficiency might decrease. On the other hand, as shown in FIG. 1B, when a reduced bandwidth that serves as the bandwidth for use changes its frequency location in every subframe, a frequency diversity effect can be achieved, and therefore the decrease of spectral efficiency can be reduced. The present embodiment might use either one of the configurations of FIG. 1A and FIG. 1B.

Now, since, as shown in FIG. 1, MTC terminals only support predetermined reduced bandwidths (for example, 1.4-MHz), MTC terminals cannot detect downlink control information (DCI) that is transmitted in the PDCCH of a wide bandwidth. So, it may be possible to allocate downlink (PDSCH) and uplink (PUSCH: Physical Uplink Shared Channel) resources to MTC terminals by using an EPDCCH (Enhanced Physical Downlink Control Channel).

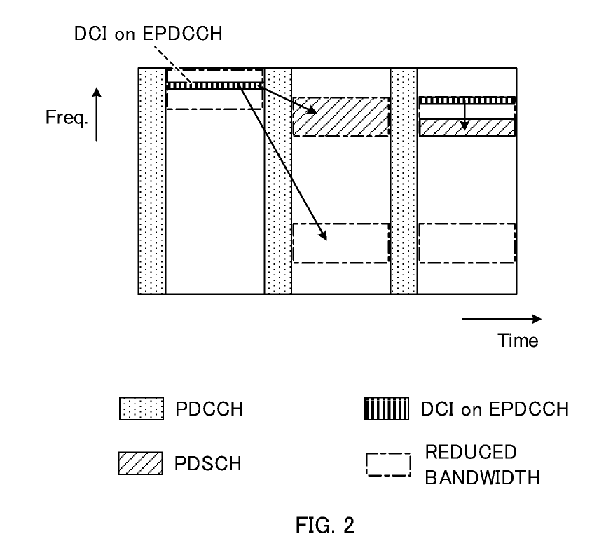

FIG. 2 is a diagram to show an example of the allocation of the EPDCCH and the PDSCH in an MTC terminal. The EPDCCH includes DCI that relates to the resources where the PDSCH is allocated. The user terminal detects the PDSCH based on the information about the allocation resources included in the DCI. Note that a radio base station may allocate the EPDCCH and the PDSCH to reduced bandwidths in the same subframe, or allocate the EPDCCH and the PDSCH to different subframes. When allocating an EPDCCH and a PDSCH to different subframes, the radio base station can allocate the EPDCCH to a subframe that is earlier in time than that for the PDSCH.

Also, the EPDCCH is formed with enhanced control channel elements (ECCEs), and the user terminal acquires downlink control information by monitoring (blind-decoding) the search spaces. As for the search spaces, a UE-specific search space (USS), which is configured individually for each UE, and a common search space (CSS), which is configured to be shared by each UE, can be configured. Note that, when search spaces are configured in an enhanced control channel, it may be possible to provide only a USS, without providing a CSS, or a configuration may be employed in which a CSS and a USS are both provided.

Furthermore, in order to receive the PDSCH and/or the EPDCCH, the user terminal has to identify the starting location (starting symbol) of the PDSCH and/or the EPDCCH in subframes. As mentioned earlier, in existing systems, a CFI to use to identify the starting location of the PDSCH is transmitted in the PCFICH.

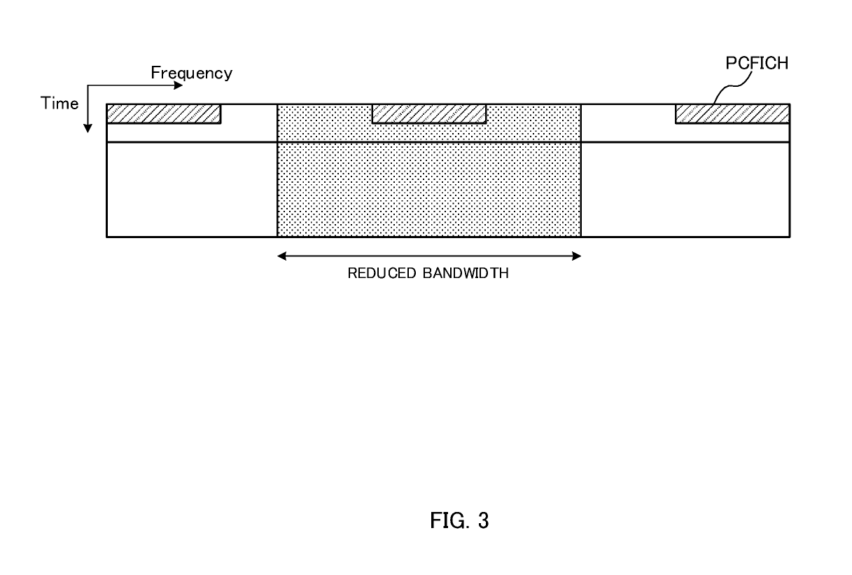

However, as shown in FIG. 3A, the PCFICH is transmitted over the system bandwidth, and therefore user terminals (for example, MTC terminals), in which the bandwidth to use is limited to reduced bandwidths, cannot detect the CFI transmitted in the existing PCFICH. So, in radio communication by MTC terminals, the method for adequately identifying the starting location of the PDSCH and/or the EPDCCH symbols is needed.

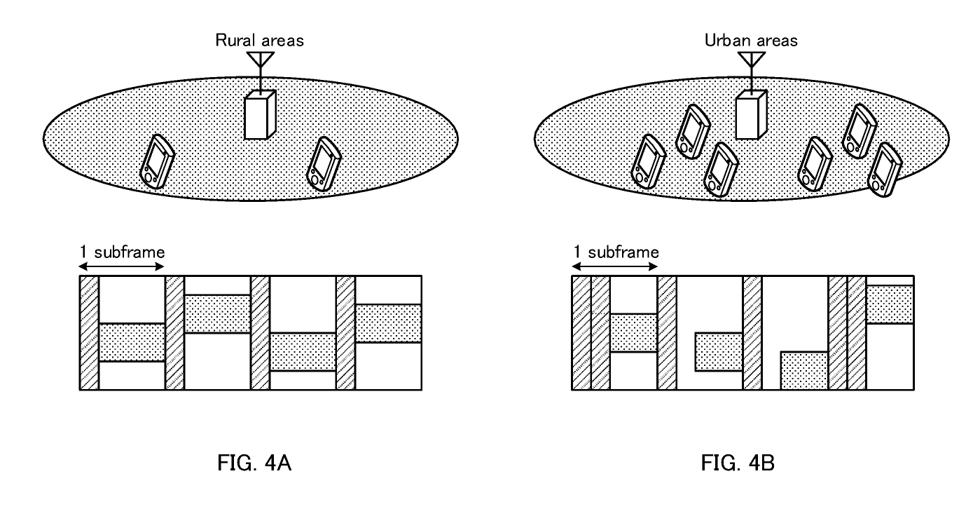

In order to allow MTC terminals to identify the starting location of the PDSCH and/or the EPDCCH, it may be possible to configure the starting location (top location) of the PDSCH and/or the EPDCCH in subframes on a fixed basis. For example, a fixed CFI value may be configured for each cell. FIG. 4 shows examples of the case where fixed CFI values are configured per cell.

FIG. 4A shows the case where the second symbol (CFI=1) from the top symbol (symbol #0) of a subframe is the starting location of a downlink signal/downlink channel (for example, the PDSCH and/or the EPDCCH) to transmit to MTC terminals. In this case, the number of symbols to use for the control field (for example, the existing PDCCH) is 1 or less. If one subframe is comprised of symbols #0 to #13, the existing PDCCH and/or others are arranged in symbol #0, symbol #1 becomes the starting location (starting symbol) of the PDSCH and/or the EPDCCH.

FIG. 4B shows the case where the third symbol (CFI=2) from the top symbol of a subframe is the starting location of a data signal (for example, the PDSCH) to transmit to MTC terminals. In this case, the number of symbols to use for the control field (for example, the existing PDCCH) is 2 or less. If one subframe is comprised of symbols #0 to #13, the existing PDCCH and/or others are arranged in symbols #0 and #1, symbol #2 becomes the starting location (starting symbol) of the PDSCH and/or the EPDCCH.

Note that the starting location of the PDSCH and/or the EPDCCH (CFI value), which is configured on a fixed basis per cell, may be determined based on the volume of traffic in each cell and so on. For example, the CFI value may be configured small in a cell in which there are few MTC terminals (for example, a cell in a rural area), and the CFI value may be configured large in a cell in which there are many MTC terminals (for example, a cell in an urban area).

In this way, by configuring the starting location of the PDSCH and/or the EPDCCH on a fixed basis per cell in radio communication by MTC terminals, MTC terminal can receive the PDSCH and the EPDCCH adequately.

However, when the starting location of the PDSCH and/or the EPDCCH is configured on a fixed basis, the scheduling in radio base stations is limited. Also, depending on the situation of communication and so on, the number of control field symbols (the starting location of the PDSCH and/or the EPDCCH) cannot be controlled flexibly, and therefore there is the problem that the use of resources cannot be optimized.

So, the present inventors have come up with the idea of controlling the allocation of the PDSCH and/or the EPDCCH flexibly by reporting information regarding the starting location of the PDSCH and/or the EPDCCH (information about the CFI value) to MTC terminals without using the existing PCFICH. In this case, the MTC terminals control the updating of the CFI value based on the CFI value information reported from the radio base station.

To be more specific, the present inventors have focused on the fact that information regarding the starting location of the PDSCH (Physical Downlink Shared Channel) and/or the EPDCCH (Enhanced Physical Downlink Control Channel) can be reported to MTC terminals by using the MIB (Master Information Block) and/or SIBs (System Information Blocks), not the PCFICH. In this case, the starting location of the PDSCH (or the CFI value), in which system information that at least includes CFI-value updating information is allocated, may be configured on a fixed basis. Note that, for the MIB/SIBs, the MIB/SIBs of existing systems may be used, the MIB/SIB s of existing systems may be enhanced and used or a new MIB/SIB s may be set forth for dedicated use for MTC terminals.

Now, assume the case where the CFI value is changed when CFI value information is transmitted by using the MIB and/or SIBs (the CFI value is changed (updated) by using the MIB and/or SIBs). In this case, in order to change the CFI value, the radio base station might report paging information (paging message), which notifies the changes of system information (SI change notifications), to user terminals. The paging information is information that is used to command user terminals (for example, MTC terminals) in RRC-idle mode and/or user terminals in RRC-connected mode to change system information.

A user terminal in RRC-connected mode refers to a user terminal that is in RRC-connected mode with a radio base station, and refers to a user terminal that can receive downlink signals from the radio base station via RRC signaling and so on. A user terminal in RRC-idle mode refers to a user terminal that is not in RRC-connected mode with a radio base station, and a user terminal in RRC-idle mode performs DRX (Discontinuous Reception) reception. Furthermore, a user terminal in RRC-idle mode receives paging information that is transmitted at predetermined timings, in DRX reception.

Furthermore, a user terminal in RRC-idle mode monitors the paging channel in order to detect incoming calls, system information changes, and so on. A user terminal in RRC-connected mode monitors the paging channel and/or SIB 1 in order to detect system information changes and so on.

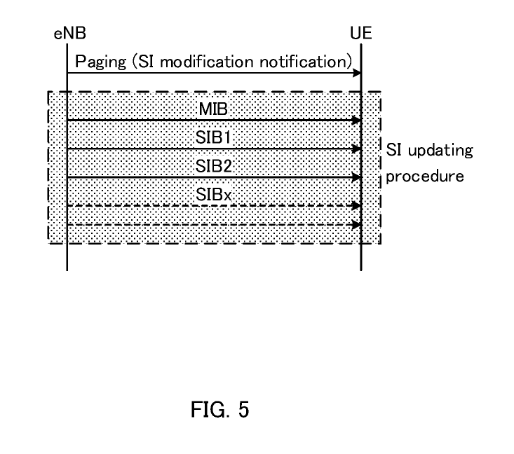

When a change of system information is notified in paging information, a user terminal operates to update all the system information. For example, as shown in FIG. 5, when a user terminal receives paging information to notify a change of system information, the user terminal receives the MIB and a plurality of SIBs, and thereby updates the system information (including the CFI value). In this way, by signaling information about the CFI value in the MIB and/or SIBs, it is possible to update the CFI value adequately, in MTC terminals, following system information change commands included in paging information.

Meanwhile, the present inventors have found out that, if the area to allocate paging information (the starting location of the symbols where paging information is arranged) changes, this might lead to cases where MTC terminals (in particular, MTC terminals in RRC-idle mode) are unable to detect paging information.

When paging information is allocated to a PDSCH and transmitted, an MTC terminal has to know the starting location of the PDSCH where the paging information is allocated. However, if the starting location of the PDSCH (for example, the CFI value) directed to the MTC terminal is changed while the MTC terminal is in idle mode (in particular, while the MTC terminal is in idle mode and moving), the MTC terminal is unable to properly recognize the change of the CFI value. As a result, the MTC terminal may become unable to receive the paging information adequately.

So, the present inventors have come up with the idea that, when the starting location of the PDSCH and/or the EPDCCH (CFI value) is controlled and changed in radio communication between radio base stations and MTC terminals, the starting location of paging information and/or the starting location of the control signal that indicates allocation information of this paging information can be configured on a fixed basis. By this means, even if an MTC terminal is in RRC-idle mode, the MTC terminal can still receive the paging information properly.

The starting location of paging information may be, for example, the starting symbol of a PDSCH, in which this paging information is arranged (starting symbol for paging info.). Also, the starting location of a control signal that indicates paging information allocation information may be, for example, the starting symbol of a common search space where this control signal is allocated (starting symbol for CSS).

Furthermore, the present inventors have focused on the point that, when, to update the CFI value, a change of system information is commanded by placing a system information update notification (SI change notification) in paging information, MTC terminals have to, unnecessarily, update all the system information.

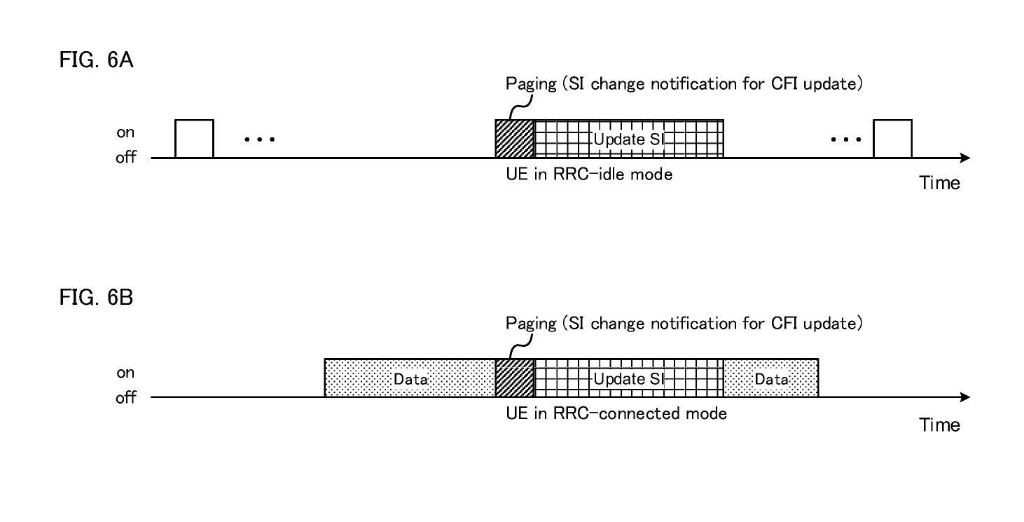

For example, if a user terminal in RRC-idle mode receives, during the DRX receiving operation, paging information that includes a system information change notification for CFI updating, the user terminal returns to sleep mode after changing all the system information (see FIG. 6A). Also, if a user terminal in RRC-connected mode receives paging information that includes a system information change notification for updating the CFI value, the user terminal has to re-start receiving data after changing all the system information (see FIG. 6B).

So, the present inventors have come up with the idea of controlling the updating of the CFI value in MTC terminals by using a method of notification that does not use the system information change notification (SI change notification) included in paging information. As one embodiment, the present inventors have come with the idea of controlling the updating of the CFI value by placing CFI-related information in an information field other than the system information change notification field (SI change notification field), in paging information. Note that the CFI-related information refers to pieces of information that have to do with the CFI, and indicates whether or not the CFI is to be changed and/or the CFI value. By this means, it is possible to reduce the time it takes to update system information, reduce the increase of power consumption, and so on.

Now, embodiments of the present invention will be described below. Although, in each embodiment, MTC terminals will be shown as an example of user terminals in which the bandwidth to use is limited to reduced bandwidths, the application of the present invention is not limited to MTC terminals. Furthermore, although 6-PRB (1.4-MHz) reduced bandwidths will be described below, the present invention can be applied to other reduced bandwidths as well, based on the present description.

### First Example

A case will be described with a first example where the starting location of paging information and/or the starting location of the search space that is detected in order to acquire this paging information are configured on a fixed basis. Note that, although the first example is particularly suitable for application to MTC terminals in RRC-idle mode, this is by no means limiting. Furthermore, in the following description, a case in which a common search space (CSS) is configured in an EPDCCH to transmit to MTC terminals and a case in which no such CSS is configured will be described. A case in which paging information is not detected by using a CSS is an example of a case in which no CSS is configured.

<When CSS is Configured>

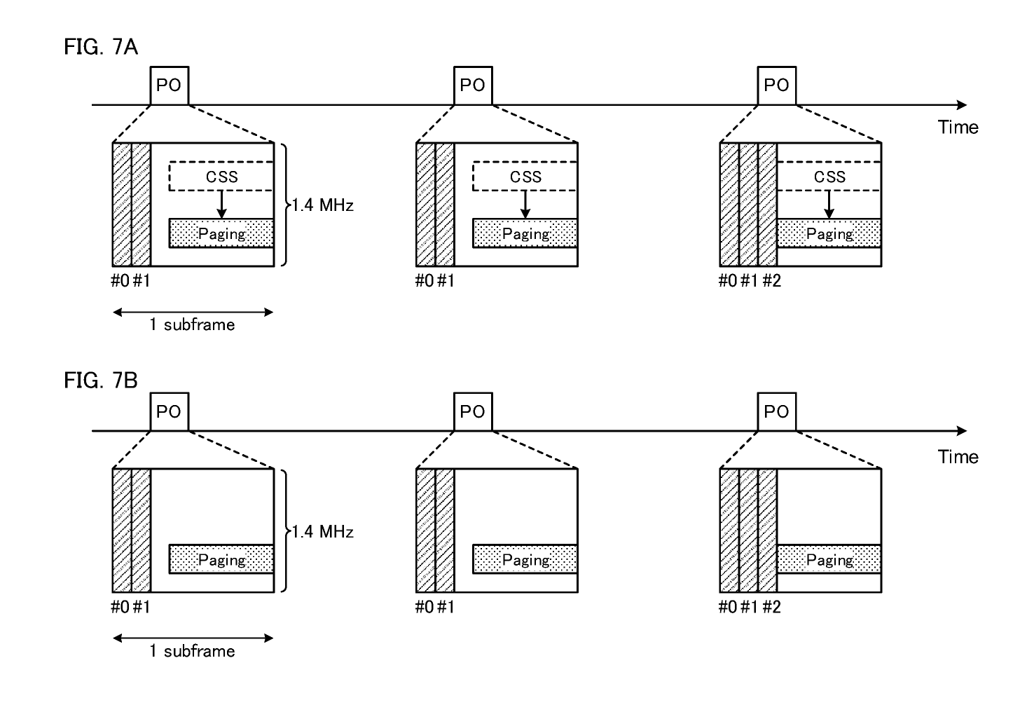

When a CSS is configured, the starting location of the symbols (starting symbol) in which the CSS is provided is configured on a fixed basis (see FIG. 7A). FIG. 7A shows a case where the fourth symbol (symbol #3) from the top of a predetermined subframe is the starting location of CSS symbols (CFI=3). Obviously, the starting location of CSS symbols, which is configured fixed, may assume other values (for example, symbol #1 (CFI=1), symbol #2 (CFI=2) and so on).

A CSS refers to an area which each MTC terminal detects in common, with respect to a plurality of ECCEs that constitute an EPDCCH. To be more specific, this is an area which a plurality of MTC terminals try to detect by blind decoding. An MTC terminal detects the CSS in a predetermined subframe, and detects paging information based on the information acquired by the detection (for example, paging information allocation information). Note that a CSS used in an EPDCCH may be referred to as an “eCSS.”

A subframe, in which a CSS is configured on a fixed basis, can be used as a predetermined subframe for configuring a CSS that at least includes paging information allocation information. When a CSS to include paging allocation information and paging information are allocated to the same subframe, at least the starting location of the CSS symbols may be configured fixed, in this subframe (for example, PO: Paging Occasion). MTC terminals can receive information about a subframe (PO), in which paging information is configured, in advance, in SIBs and so on. Furthermore, it is also possible to configure the starting location of CSS symbols on a fixed basis in all subframes, regardless of whether these subframes are predetermined subframes (for example, POs).

Also, when detecting paging information by using a CSS, the starting location of the symbols where the paging information is allocated (for example, a PDSCH to include paging information) may be configured on a fixed basis, as is the case with a CSS. In this case, the starting locations of the symbols for the CSS and the symbols for the paging information symbols can be configured the same. Note that the symbols in which the paging information is configured need not be configured on a fixed basis, and their starting location may be specified based on the CSS. In this case, the symbols in which the paging information is configured can be configured before the starting location of the CSS.

In this way, by configuring at least the starting location of CSS symbols, which can be used to detect paging information, on a fixed basis, an MTC terminal can received paging information adequately even in RRC-idle mode. By this means, when the updating of the CFI values is controlled based on paging information, MTC terminals can change the CFI value adequately.

<When CSS is not Configured>

When no CSS is configured, in a predetermined subframe (for example, PO), the starting location of the symbols in which paging information is allocated (for example, a PDSCH to include paging information) is configured on a fixed basis (see FIG. 7B). FIG. 7B shows a case where the fourth symbol (symbol #3) from the top of a predetermined subframe is the starting location of the area to allocate paging information. Obviously, the starting location of paging information symbols, which is configured fixed, may assume other values (for example, symbol #1, symbol #2, and so on).

In this way, by configuring the starting location of paging information in predetermined subframes on a fixed basis, it is possible to allow MTC terminals to detect paging information adequately. Note that information that relates to the allocation of paging information (for example, subframe information and so on) may be set forth in the specification, or may be reported to MTC terminals in advance.

### Second Example

A case will be described with a second example where information about the CFI is reported to MTC terminals by using a method of notification that does not use the system information change notification (SI change notification) included in paging information. Note that, although the second example is particularly suitable for application to MTC terminals in RRC-idle mode, the second example can be applied to MTC in RRC-connected mode as well. Furthermore, the second example can be adequately combined and applied with the first example.

<First Method>

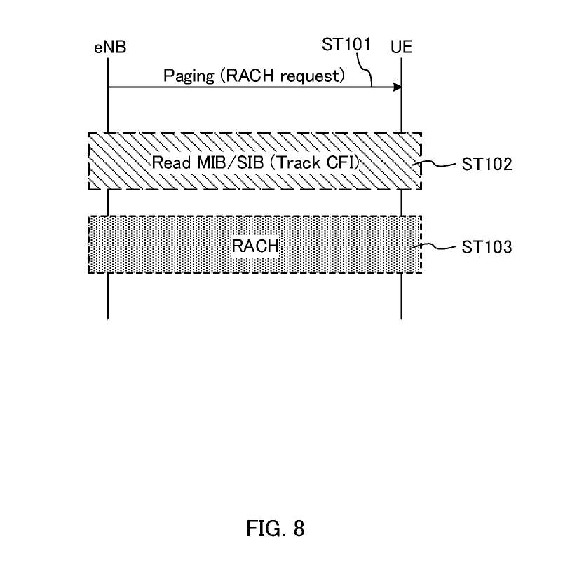

As a first method, a case will be described, with reference to FIG. 8, in which an MTC terminal acquires (updates) the CFI value based on a RACH request included in paging information.

A radio base station transmits a RACH request to an MTC terminal (for example, RRC-idle mode) by using paging information (paging message) (ST101). The RACH request is configured in the RACH request field of the paging information. The MTC terminal, where the RACH request is commanded, detects the MIB and/or SIBs and acquires information about the CFI value (the starting location of the PDSCH and/or the EPDCCH) before executing the random access procedure (ST102).

The MTC terminal, having acquired the CFI value, transmits and receives signals (for example, in the random access procedure), taking this CFI value into consideration (ST103). In this way, by allowing an MTC terminal to update the CFI based on a RACH request, the MTC terminal can adequately identify the starting location of the PDSCH and/or the EPDCCH transmitted in the random access procedure. As a result of this, it is possible to improve spectral efficiency, and execute the random access procedure adequately.

According to the first method, the MIB and/or SIBs are detected based on a RACH requested included in paging information, and information about the CFI value is acquired. Consequently, unlike the case of acquiring information about the CFI value based on the system information change notification included in paging information, it is not necessary to update all the system information, and therefore it is possible to achieve simplified operations, reduced power consumption and so on on the MTC terminal end.

<Second Method>

As a second method, a case will be described below, in which a field for updating the CFI (also referred to as, for example, the “CFI update field”) is configured in paging information, and information about the CFI is reported to MTC terminals by using this paging information.

For example, a radio base station reports a change of the CFI value to an MTC terminal by using the CFI update field configured in paging information. The MTC terminal, having received this paging information, detects the MIB and/or SIBs in order to update the CFI value.

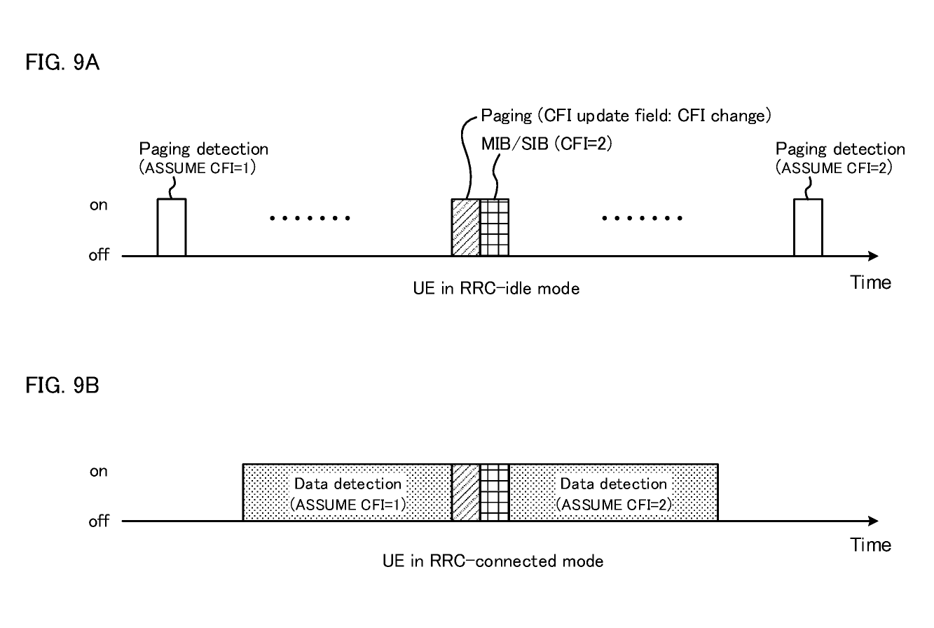

FIG. 9A illustrates a case where an MTC terminal in RRC-idle mode adopts the second method. In the case shown here, the CFI value changes from 1 to 2. The radio base station transmits paging information that includes a CFI update field to the MTC terminal in a predetermined subframe (for example, a PO). The MTC terminal, where a CFI change is reported via the paging information, detects the MIB and/or SIBs, and acquires information about the CFI value after the change.

FIG. 9B shows a case where an MTC terminal in RRC-connected mode adopts the second method. In the case shown here, the CFI value changes from 1 to 2. Before changing the CFI value, the MTC terminal assumes that the CFI value is 1, and performs the receiving operation and so on accordingly. When changing the CFI value, the radio base station transmits paging information that includes a CFI update field (indicating a CFI change) to the MTC terminal in a predetermined subframe (for example, a PO). The MTC terminal, where a CFI change is reported via the paging information, detects the MIB and/or SIBs, and acquires information about the CFI value after the change (here, CFI=2). After this, the MTC terminal assumes that the CFI value is 2, and performs the receiving operation and so on accordingly.

In this way, by configuring a CFI update field that indicates whether or not the CFI is to be updated, in paging information, it is possible to allow MTC terminals to perform only operations that relate to CFI updating. Note that the CFI update field can be configured with, for example, one bit that indicates whether or not the CFI is to be updated.

According to the second method, when an MTC terminal receives paging information that commands updating of the CFI, the MTC terminal has only to receive the MIB and/or SIBs in order to update the CFI. Consequently, unlike the case of acquiring information about the CFI value based on the system information change notification included in paging information, it is not necessary to update all the system information, and therefore it is possible to achieve simplified operations on the MTC terminal end.

<Third Method>

As a third method, a case will be described below, in which a CFI update field is configured in paging information, and in which, furthermore, information about the CFI value is configured in this CFI update field.

For example, a radio base station reports information about the CFI value (for example, the CFI value after a change) to an MTC terminal by using the CFI update field in paging information. The MTC terminal can update the CFI value based on the paging information that is received. The CFI update field can be configured with, for example, two bits.

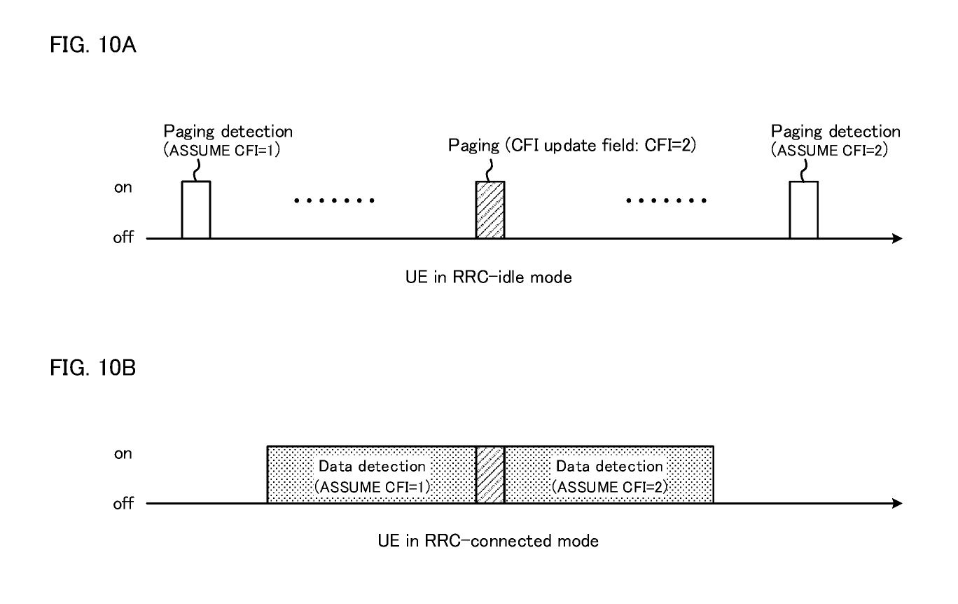

FIG. 10A shows a case where an MTC terminal in RRC-idle mode adopts the third method. The radio base station transmits paging information that includes a CFI update field (information about the CFI value) to an MTC terminal in a predetermined subframe (for example, a PO). A case is shown here in which the CFI value is changed from 1 to 2, and the MTC terminal updates the CFI value from 1 to 2, based on the paging information that is received.

FIG. 10B shows a case where an MTC terminal in RRC-connected mode adopts the third method. In the case shown here, the CFI value changes from 1 to 2. Before changing the CFI value, the MTC terminal assumes that the CFI value is 1, and receives the PDSCH and/or EPDCCH and so on that are transmitted from the radio base station.

When changing the CFI value, the radio base station transmits paging information that includes a CFI update field (information about the CFI value) to the MTC terminal in a predetermined subframe (for example, a PO). The MTC terminal changes the CFI value from 1 to 2 based on the paging information that is received. After this, the MTC terminal assumes that the CFI value is 2, and accordingly receives the PDSCH and/or the EPDCCH and others that are transmitted from the radio base station.

According to the third method, information about the CFI value is reported to an MTC terminal in paging information, so that the MTC terminal can update the CFI value based on the paging information. Consequently, unlike the first method and the second method, after paging information is received, the operation for acquiring information about the CFI value (for example, the MIB and/or SIB receiving operation) is no longer necessary. Consequently, it is possible to simplify the operations on the MTC terminal end in comparison to the first method and the second method.

### Third Example

A case will be described with a third example where information about the CFI is reported to an MTC terminal by using a notification method that does not use the system information change notification (SI change notification) included in paging information. The third example is particularly suitable for application to MTC terminals in RRC-connected mode. Furthermore, the third example can be adequately combined and applied with the configurations shown in other examples.

<RRC Signaling>

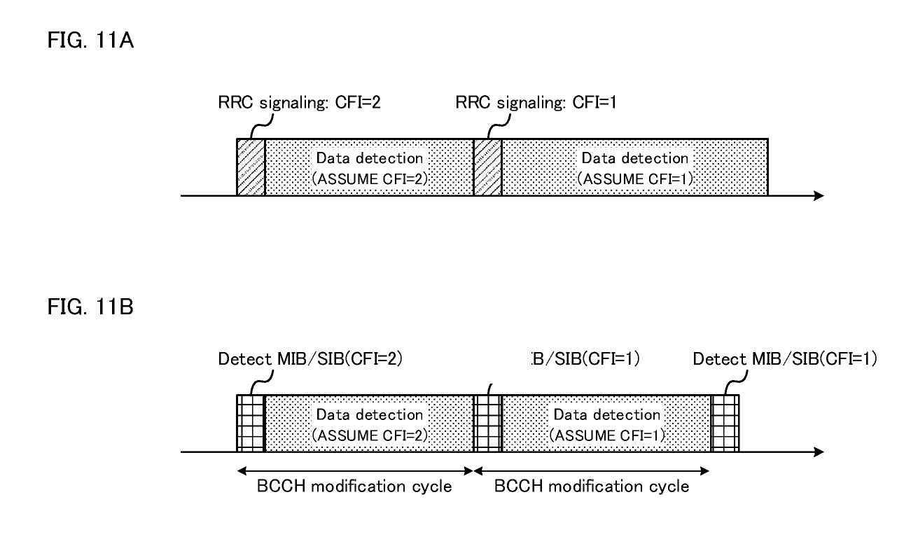

A radio base station can report information about the CFI value to an MTC terminal in RRC-connected mode by RRC signaling (see FIG. 11A). The MTC terminal identifies the starting location of the PDSCH and/or others based on the CFI value information reported in RRC signaling, and receives downlink data. In this way, by reporting information about the CFI value to an MTC terminal in RRC-connected mode by using RRC signaling, it is possible to use frequency resources effectively, and enable the MTC terminal to receive the PDSCH and so on adequately.

<MIB/SIB>

A radio base station can report information about the CFI value to an MTC terminal in RRC-connected mode by using MIBs and/or SIBs that are transmitted periodically (see FIG. 11B). In this case, it is possible to place the information about the CFI value in the MIBs and/or SIBs that are transmitted in a predetermined cycle. The predetermined cycle may be, for example, the broadcast channel modification cycle (BCCH modification cycle), which is configured as the cycle to change system information.

The MTC terminal identifies the starting location of the PDSCH and/or others based on the CFI value information included in the MIBs and/or SIBs transmitted in a predetermined cycle, and receives downlink data. In this way, by reporting information about the CFI value to an MTC terminal in RRC-connected mode by using MIBs and/or SIBs that are transmitted periodically, it is possible to use frequency resources effectively, and enable the MTC terminal to receive the PDSCH and so on adequately.

(Structure of Radio Communication System)

Now, the structure of the radio communication system according to an embodiment of the present invention will be described below

In this radio communication system, the radio communication methods according to the embodiments of the present invention are employed. Note that the radio communication methods of the above-described embodiments may be applied individually or may be applied in combination. Here, although MTC terminals will be shown as examples of user terminals in which the bandwidth to use is limited to reduced bandwidths, the present invention is by no means limited to MTC terminals.

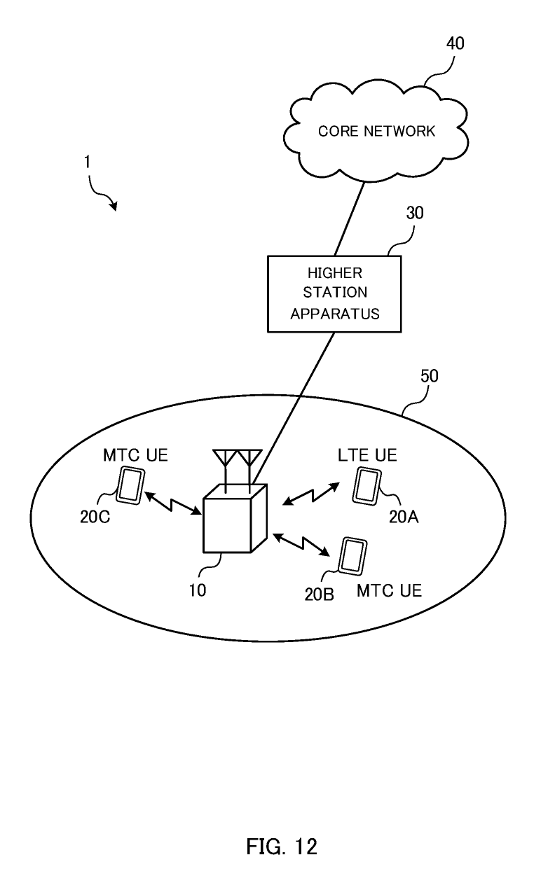

FIG. 12 is a diagram to show a schematic structure of the radio communication system according to an embodiment of the present invention. The radio communication system 1 shown in FIG. 12 is an example of employing an LTE system in the network domain of a machine communication system. The radio communication system 1 can adopt carrier aggregation (CA) and/or dual connectivity (DC) to group a plurality of fundamental frequency blocks (component carriers) into one, where the LTE system bandwidth constitutes one unit. Also, although, in this LTE system, the system bandwidth is configured to maximum 20 MHz in both the downlink and the uplink, this configuration is by no means limiting. Note that the radio communication system 1 may be referred to as “SUPER 3G,” “LTE-A” (LTE-Advanced), “IMT-Advanced,” “4G,” “5G,” “FRA” (Future Radio Access) and so on.

The radio communication system 1 is comprised of a radio base station 10 and a plurality of user terminals 20A, 20B and 20C that are connected with the radio base station 10. The radio base station 10 is connected with a higher station apparatus 30, and connected with a core network 40 via the higher station apparatus 30. Note that the higher station apparatus 30 may be, for example, an access gateway apparatus, a radio network controller (RNC), a mobility management entity (MME) and so on, but is by no means limited to these.

A plurality of user terminal 20A, 20B and 20C can communicate with the radio base station 10 in a cell 50. For example, the user terminal 20A is a user terminal that supports LTE (up to Rel-10) or LTE-Advanced (including Rel-10 and later versions) (hereinafter referred to as an “LTE terminal”), and the other user terminals 20B and 20C are MTC terminals that serve as communication devices in machine communication systems. Hereinafter the user terminals 20A, 20B and 20C will be simply referred to as “user terminals 20,” unless specified otherwise.

Note that the MTC terminals 20B and 20C are terminals that support various communication schemes including LTE and LTE-A, and are by no means limited to stationary communication terminals such electric (gas) meters, vending machines and so on, and can be mobile communication terminals such as vehicles. Furthermore, the user terminals 20 may communicate with other user terminals directly, or communicate with other user terminals via the radio base station 10.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data and higher layer control information, predetermined SIBs (System Information Blocks), a paging channel (PCH)/paging information and so on are communicated in the PDSCH. Also, the MIB (Master Information Block) and so on are communicated by the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH is frequency-division-multiplexed with the PDSCH (downlink shared data channel) and used to communicate DCI and so on, like the PDCCH.

In the radio communication system 1, an uplink shared channel (PUSCH (Physical Uplink Shared CHannel)), which is used by each user terminal 20 on a shared basis, an uplink control channel (PUCCH (Physical Uplink Control CHannel)), a random access channel (PRACH (Physical Random Access CHannel)) and so on are used as uplink channels. User data and higher layer control information are communicated by the PUSCH. Also, downlink radio quality information (CQI: Channel Quality Indicator), delivery acknowledgement signals and so on are communicated by the PUCCH. By means of the PRACH, random access preambles (RA preambles) for establishing connections with cells are communicated.

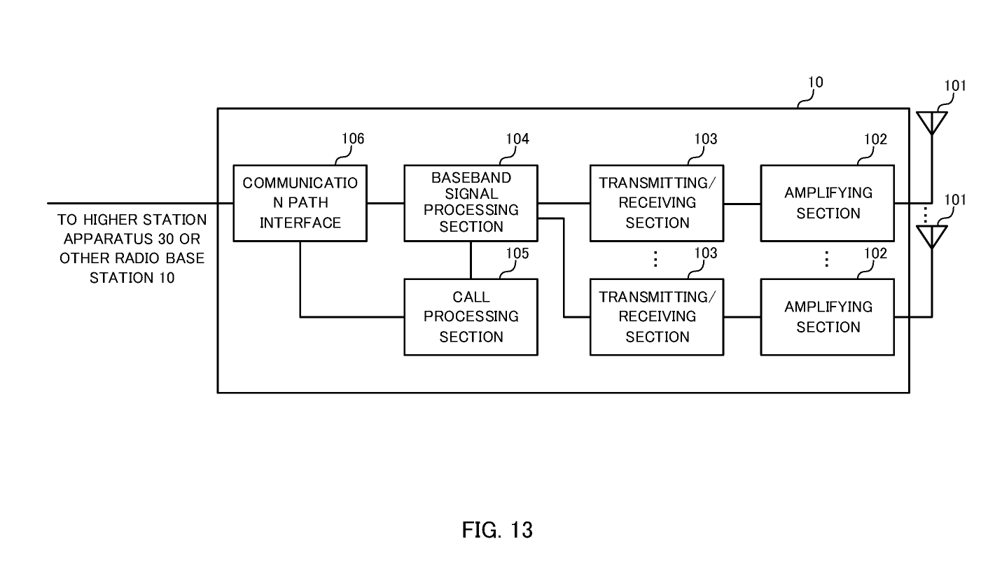

FIG. 13 is a diagram to show an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that the transmitting/receiving sections 103 are comprised of transmitting sections and receiving sections.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts baseband signals that are pre-coded and output from the baseband signal processing section 104 on a per antenna basis, into a radio frequency band. The radio frequency signals subjected to frequency conversion in the transmitting/receiving sections 103 are amplified in the amplifying sections 102, and transmitted from the transmitting/receiving antennas 101. The transmitting/receiving sections 103 can transmit and receive various signals in reduced bandwidths that are limited more than the system bandwidth.

For example, the transmitting sections 103 can transmit the MIB, SIBs, paging information and son, in which information about the CFI is included. For the transmitting/receiving sections 103, transmitters/receivers, transmitting/receiving circuits or transmitting/receiving devices that can be described based on common understanding of the technical field to which the present invention pertains can be used.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. The communication path interface 106 transmits and receives signals to and from neighboring radio base stations 10 (backhaul signaling) via an inter-base station interface (for example, optical fiber, the X2 interface, etc.).

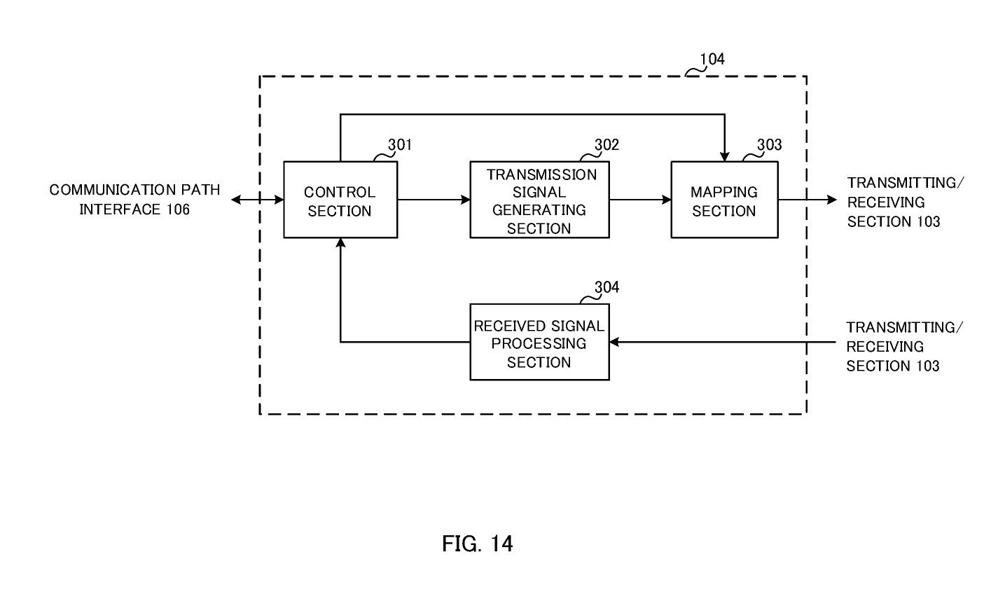

FIG. 14 is a diagram to show an example of a functional structure of a radio base station according to the present embodiment. Note that, although FIG. 14 primarily shows functional blocks that pertain to characteristic parts of the present embodiment, the radio base station 10 has other functional blocks that are necessary for radio communication as well. As shown in FIG. 14, the baseband signal processing section 104 has a control section (scheduler) 301, a transmission signal generating section (generating section) 302, a mapping section 303 and a received signal processing section 304.

The control section (scheduler) 301 controls the scheduling of (for example, allocates resources to) downlink data signals that are transmitted in the PDSCH and downlink control signals that are communicated in the PDCCH and/or the EPDCCH. Also, the control section 301 controls the scheduling of system information, synchronization signals, paging information, CRSs (Cell-specific Reference Signals), CSI-RSs (Channel State Information Reference Signals) and so on. Furthermore, the control section 301 controls the scheduling of uplink reference signals, uplink data signals that are transmitted in the PUSCH, uplink control signals that are transmitted in the PUCCH and/or the PUSCH, random access preambles that are transmitted in the PRACH, and so on.

The control section 301 controls the transmission signal generating section 302 and mapping section 303 to allocate various types of signals to reduced bandwidths and transmit these to the user terminals 20. For example, control section 301 exerts control so that downlink signals such as downlink system information (the MIB and SIBs), paging information, the EPDCCH and/or others are allocated to reduced bandwidths.

In predetermined subframes in which paging information is configured, the control section 301 configures the starting location of an EPDCCH, in which paging information allocation information is included (in particular, the starting location of the common search space), on a fixed basis. In this case, the control section 301 configures the starting location of the common search space fixed, in predetermined subframes in which at least paging information is transmitted (first example).

Alternatively, in predetermined subframes in which paging information is configured, the control section 301 configures the starting location of the symbols where paging information is arranged (for example, the starting location of a PDSCH where a PCH is allocated), on a fixed basis, without configuring the common search space (first example).

Also, the control section 301 exerts control so that an MTC terminal, when receiving paging information that includes a random access request, receives the MIB and/or SIBs and acquires information about the CFI value, before executing the random access procedure. Also, the control section 301 exerts control so that information about the CFI (whether or not the CFI is to be changed, information about the CFI value, and so on) is placed and transmitted in paging information.

For the control section 301, a controller, a control circuit or a control device that can be described based on common understanding of the technical field to which the present invention pertains can be used.

The transmission signal generating section 302 generates DL signals based on commands from the control section 301 and outputs these signals to the mapping section 303. For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on.

Also, the transmission signal generating section 302 can generate paging information that carries information about the CFI. For the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 to predetermined reduced bandwidth radio resources (for example, maximum 6 resource blocks) based on command from the control section 301, and outputs these to the transmitting/receiving sections 103.

For example, the mapping section 303 implements mapping so that the starting location of paging information and/or the starting location of the control signal that indicates allocation information of this paging information are fixed. Also, the mapping section 303 controls the starting location of a downlink data signal (PDSCH) and a downlink control signal (EPDCCH) based on the CFI value. Note that, for the mapping section 303, mapper, a mapping circuit or a mapping device that can be described based on common understanding of the technical field to which the present invention pertains can be used.

The received signal processing section 304 performs the receiving processes (for example, demapping, demodulation, decoding and so on) of the UL signals that are transmitted from the user terminal (for example, delivery acknowledgement signals (HARQ-ACKs), data signals that are transmitted in the PUSCH, random access preambles that are transmitted in the PRACH, and so on). The processing results are output to the control section 301.

Also, by using the received signals, the received signal processing section 304 may measure the received power (for example, the RSRP (Reference Signal Received Power)), the received quality (for example, the RSRQ (Reference Signal Received Quality)), channel states and so on, by using the received signals. The measurement results may be output to the control section 301.

The receiving process section 304 can be constituted by a signal processor, a signal processing circuit or a signal processing device, and a measurer, a measurement circuit or a measurement device that can be described based on common understanding of the technical field to which the present invention pertains.

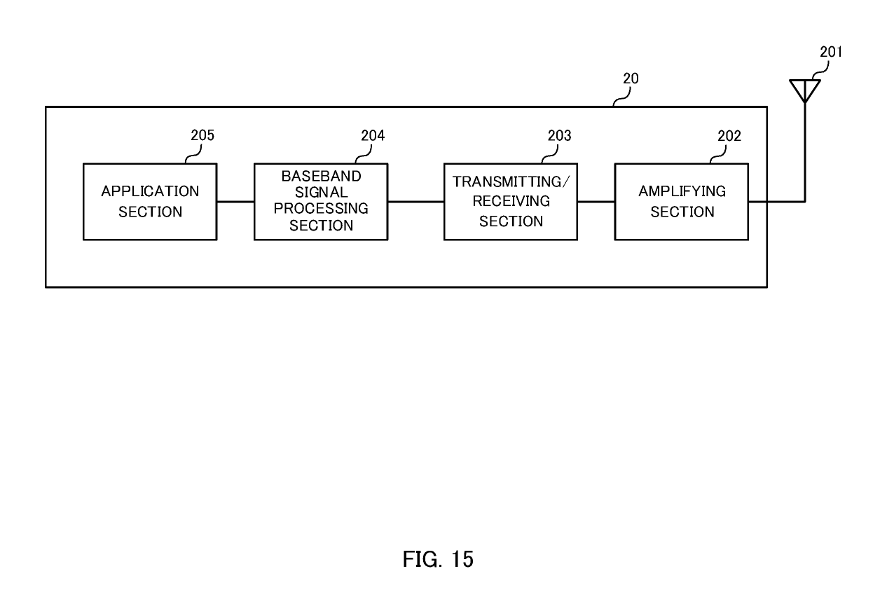

FIG. 15 is a diagram to show an example of an overall structure of a user terminal according to the present embodiment. Note that, although the details will not be described here, normal LTE terminals may operate and act as MTC terminals. A user terminal 20 has a transmitting/receiving antenna 201, an amplifying section 202, a transmitting/receiving section 203, a baseband signal processing section 204 and an application section 205. Note that the transmitting/receiving section 203 is comprised of a transmitting section and a receiving section. Also, the user terminal 20 may have a plurality of transmitting/receiving antennas 201, amplifying sections 202, transmitting/receiving sections 203 and so on.

A radio frequency signal that is received in the transmitting/receiving antenna 201 is amplified in the amplifying section 202. The transmitting/receiving section 203 receives the downlink signal amplified in the amplifying section 202. The received signal is subjected to frequency conversion and converted into the baseband signal in the transmitting/receiving section 203, and output to the baseband signal processing section 204.

The transmitting/receiving section 203 can receive paging information that is transmitted in predetermined subframes. In this case, the transmitting/receiving section 203 can detect a common search space that is allocated in a fixed starting location in the predetermined subframes, and receive the paging information indicated in the common search space. Also, when receiving paging information that includes a random access request, the transmitting/receiving section 203 can receive the MIB and/or SIBs and acquire information about the CFI value.

Also, when receiving information about the change of the CFI value, which is included in paging information, the transmitting/receiving section 203 can receive the MIB and/or SIBs and acquire information about the CFI value. Also, when a user terminal is in RRC-connected mode, the transmitting/receiving section 203 can acquire information about the CFI value, included in higher layer signaling. Alternatively, when a user terminal is in RRC-connected mode, the transmitting/receiving section 203 can acquire information about the CFI value, included in MIBs and/or SIBs that are transmitted at predetermined timings.

For the transmitting/receiving sections 203, transmitters/receivers, transmitting/receiving circuits or transmitting/receiving devices that can be described based on common understanding of the technical field to which the present invention pertains can be used.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

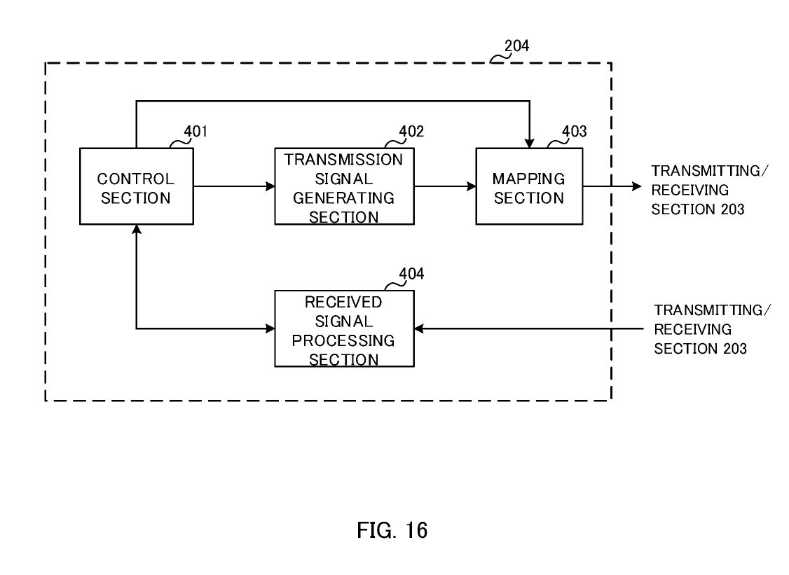

FIG. 16 is a diagram to show an example of a functional structure of a user terminal according to the present embodiment. Note that, although FIG. 16 primarily shows functional blocks that pertain to characteristic parts of the present embodiment, the user terminal 20 has other functional blocks that are necessary for radio communication as well. As shown in FIG. 16, the baseband signal processing section 204 provided in the user terminal 20 has a control section 401, a transmission signal generating section 402, a mapping section 403 and a received signal processing section 404.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on. To be more specific, the control section 401 controls the transmission signal generating section 402 and the mapping section 403.

The control section 401 can control the receipt of a downlink shared channel and/or an enhanced downlink control channel by using information about the CFI (Control Format Indicator) value, which is acquired based on paging information. For example, the control section 401 exerts control so that information about the CFI value is acquired from the MIB and/or SIBs, based on information included in paging information.

For example, when paging information that includes a random access request (RACH request) is received, the control section 401 exerts control so that the MIB and/or SIBs are received and information about the CFI value is acquired. Alternatively, when information about the change of the CFI value, included in paging information, is received, the control section 401 can receive the MIB and/or SIBs and acquire information about the CFI value. Alternatively, when information about the CFI value is included in paging information, the control section 401 can acquire information about the CFI value from the paging information.

For the control section 401, a controller, a control circuit or a control device that can be described based on common understanding of the technical field to which the present invention pertains can be used.

The transmission signal generating section 402 generates UL signals based on commands from the control section 401, and outputs these signals to the mapping section 403. For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal.

For the transmission signal generating section 402, a signal generator, a signal generating circuit or a signal generating device that can be described based on common understanding of the technical field to which the present invention pertains can be used.

The mapping section 403 maps the uplink signals generated in the transmission signal generating section 402 to radio resources (maximum 6 resource blocks) based on commands from the control section 401, and output these to the transmitting/receiving sections 203. For the mapping section 403, mapper, a mapping circuit or a mapping device that can be described based on common understanding of the technical field to which the present invention pertains can be used.

The received signal processing section 404 performs receiving processes (for example, demapping, demodulation, decoding and so on) of DL signals (for example, downlink control signals transmitted from the radio base station, downlink data signals transmitted in the PDSCH, and so on). The received signal processing section 404 outputs the information received from the radio base station 10, to the control section 401. The received signal processing section 404 outputs, for example, broadcast information, system information, paging information, RRC signaling, DCI and so on, to the control section 401.

Also, the received signal processing section 404 may measure the received power (RSRP), the received quality (RSRQ) and channel states, by using the received signals. Note that the measurement results may be output to the control section 401.

The received signal processing section 404 can be constituted by a signal processor, a signal processing circuit or a signal processing device, and a measurer, a measurement circuit or a measurement device that can be described based on common understanding of the technical field to which the present invention pertains. Also, the received signal processing section 404 can constitute the receiving section according to the present invention.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of radio base stations 10 and user terminals 20 may be implemented using hardware such as an ASIC (Application-Specific Integrated Circuit), a PLD (Programmable Logic Device), an FPGA (Field Programmable Gate Array) and so on. Also, the radio base stations 10 and user terminals 20 may be implemented with a computer device that includes a processor (CPU), a communication interface for connecting with networks, a memory and a computer-readable storage medium that holds programs.

Here, the processor and the memory are connected with a bus for communicating information. Also, the computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes. Here, these programs have only to be programs that make a computer execute each operation that has been described with the above embodiments. For example, the control section 401 of the user terminals 20 may be stored in the memory and implemented by a control program that operates on the processor, and other functional blocks may be implemented likewise.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2015-011091, filed on Jan. 23, 2015, including the specification, drawings and abstract, is incorporated herein by reference in its entirety.

1. A user terminal, in which a bandwidth to use is limited to a partial reduced bandwidth in a system bandwidth, the user terminal comprising:
a receiving section that receives paging information that is transmitted in a predetermined subframe; and
a control section that controls receipt of a downlink shared channel and/or an enhanced downlink control channel by using information about a CFI (Control Format indicator) value that is acquired based on the paging information,
wherein the receiving section detects a common search space, which is allocated in a fixed starting location in the predetermined subframe, and receives the paging information indicated in the common search space.

2. A user terminal, in which a bandwidth to use is limited to a partial reduced bandwidth in a system bandwidth, the user terminal comprising:
a receiving section that receives paging information that is transmitted in a predetermined subframe; and
a control section that controls receipt of a downlink shared channel and/or an enhanced downlink control channel by using information about a CFI (Control Format Indicator) value that is acquired based on the paging information,
wherein the receiving section detects the paring information, which is allocated in a fixed starting location in the predetermined subframe.

3. The user terminal according to claim 1, wherein the starting location of the common search space is fixed in the predetermined subframe in which at least the paging information is transmitted.

4. The user terminal according to claim 1, wherein, when paging information that includes a random access request is received, the receiving section receives an MIB (Master Information Block) and/or an SIB (System Information Block) and acquires the information about the CFI value.

5. The user terminal according to claim 1, wherein, when information about a change of the CFI value included in the paging information is received, the receiving section receives an MIB and/or an SIB and acquires the information about the CFI value.

6. The user terminal according to claim 1, wherein the information about the CFI value is included in the paging information.

7. The user terminal according to claim 1, wherein, when the user terminal is in RRC-connected mode, the receiving section acquires information about the CFI value, included in higher layer signaling.

8. The user terminal according to claim 1, wherein, when the user terminal is in RRC-connected mode, the receiving section acquires information about the CFI value, included in an MIB and/or an SIB transmitted at a predetermined timing.

9. A radio base station that communicates with a user terminal in which a bandwidth to use is limited to a partial reduced bandwidth in a system bandwidth, the radio base station comprising:
a generation section that generates paging information that includes information about a CFI;
a transmission section that transmits the paging information in a predetermined subframe; and
a control section that controls allocation of a downlink shared channel and/or enhanced downlink control channel based on a CFI (Control Format Indicator) value,
wherein the transmission section allocates the paging information in a fixed starting location in the predetermined subframe and transmits the paging information.

10. (canceled)

11. The user terminal according to claim 2, wherein, when paging information that includes a random access request is received, the receiving section receives an MIB (Master Information Block) and/or an SIB (System Information Block) and acquires the information about the CFI value.

12. The user terminal according to claim 2, wherein, when information about a change of the CFI value included in the paging information is received, the receiving section receives an MIB and/or an SIB and acquires the information about the CFI value.

13. The user terminal according to claim 2, wherein the information about the CFI value is included in the paging information.

14. The user terminal according to claim 2, wherein, when the user terminal is in RRC-connected mode, the receiving section acquires information about the CFI value, included in higher layer signaling.

15. The user terminal according to claim 2, wherein, when the user terminal is in RRC-connected mode, the receiving section acquires information about the CFI value, included in an MIB and/or an SIB transmitted at a predetermined timing.
